(19) United States
(12) Patent Application Publication
(10) Pub. No.: US 2024/0259675 A1
(43) Pub. Date: Aug. 1, 2024

(54) CONTROL DEVICE USED IN MOBILITY SUPPORT SYSTEM

(71) Applicant: TOYOTA JIDOSHA KABUSHIKI KAISHA, Toyota-shi (JP)

(72) Inventors: Hiroaki KAWAMURA, Nagoya-shi (JP); Kohei SHINTANI, Nisshin-shi (JP)

(73) Assignee: TOYOTA JIDOSHA KABUSHIKI KAISHA, Toyota-shi (JP)

(21) Appl. No.: 18/530,805

(22) Filed: Dec. 6, 2023

(30) Foreign Application Priority Data
Jan. 27, 2023 (JP) 2023-010659

(51) Int. Cl. H04N 23/60; H04N 23/65

(52) U.S. Cl. CPC H04N 23/64; H04N 23/651

(57) ABSTRACT

A control device used in a mobility support system that supports walking of a user using a white cane by notifying the user of information, the white cane includes an imaging device, the information is generated based on an image captured by the imaging device, and the control device includes a predetermined action determination unit that determines whether the user has performed a predetermined action using the white cane based on a movement of the white cane, and a start processing unit that executes a start process of the imaging device when the predetermined action determination unit determines that the predetermined action has occurred.

### CROSS-REFERENCE TO RELATED APPLICATION

This application claims priority to Japanese Patent Application No. 2023-010659 filed on Jan. 27, 2023 incorporated herein by reference in its entirety.

### BACKGROUND

### 1. Technical Field

The present disclosure relates to a control device used in a mobility support system.

### 2. Description of Related Art

A device disclosed in Re-publication of PCT International Publication No. 2018-025531 (WO 2018-025531) is known as a mobility support device that performs walking support for a pedestrian such as a visually impaired person. WO 2018-025531 discloses a technique including a direction determination unit that determines the direction in which a person who acts without using vision (a visually impaired person) walks and a guide information generation unit that generates guide information for guiding the visually impaired person to walk in the determined direction. In the technique, the walking direction of the visually impaired person is determined by matching an image from a camera carried by the visually impaired person and a reference image stored in advance to guide the visually impaired person with the walking direction by voice or the like.

### SUMMARY

However, object recognition using conventional cameras requires the camera to be activated all the time to continue capturing images in order to recognize temporary obstacles such as construction structures and signboards, and when used portably, there is room for improvement from a perspective of required electric power.

The present disclosure provides a control device that can reduce the required electric power of a mobility support system by starting an imaging device used when performing mobility support of a user according to the needs of the user.

The control device used in the mobility support system according to an aspect of the present disclosure is a control device used in a mobility support system that supports walking of a user using a white cane by notifying the user of information, the white cane includes an imaging device, the information is generated based on an image captured by the imaging device, and the control device includes a predetermined action determination unit that determines whether the user has performed a predetermined action using the white cane based on a movement of the white cane, and a start processing unit that executes a start process of the imaging device when the predetermined action determination unit determines that the predetermined action has been performed.

According to the above aspect, since the imaging device can be started according to the predetermined action using the white cane of the user, that is, the imaging device can be started according to the intention of the user to check the object, the imaging device can be started according to the needs of the user. Therefore, there is no need to keep the imaging device activated all the time, and the required electric power of the mobility support system can be reduced.

In the aspect above, the movement of the white cane may be a movement of the white cane when the user is standing still, and the predetermined action may be a predetermined action when the user is standing still.

Usually, when the user walks, the user contacts the white cane to the ground or obstacles. Further, when the user wants to check an object, it is assumed that the user stands still. Therefore, it is possible to determine the intention of the user to check an object based on the movement of the white cane when the user is standing still, and as a result, the imaging device can be started more accurately according to the needs of the user.

In the aspect above, the predetermined action may be the user hitting the same object multiple times using the white cane.

The action of hitting the same object multiple times using the white cane is an action that is easy for the user to perform when checking the object. Therefore, it is possible to start the imaging device according to the needs of the user.

The control device in the above aspect may further include an image acquisition unit that acquires an image captured by the imaging device after the imaging device is started by the start processing unit, and a stop processing unit that executes a stop process of the imaging device when the image is acquired by the image acquisition unit.

Therefore, it is possible to appropriately stop the imaging device, and the required electric power of the mobility support system can be reduced.

In the present disclosure, it is possible to start the imaging device used when performing mobility support of the user according to the needs of the user. Therefore, there is no need to keep the imaging device activated all the time. Therefore, the required electric power of the mobility support system can be reduced.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing the system configuration of a mobility support system and the appearance of a white cane according to an embodiment;

FIG. 2 is a block diagram showing the schematic configuration of the control system of the mobility support system;

FIG. 3 is a block diagram showing the functional configuration of the control device;

FIG. 4 is a diagram for explaining a predetermined action in the embodiment;

FIG. 5 is an example of an image captured by the camera; and

FIG. 6 is a flowchart showing the flow of processing executed by the control device.

### DETAILED DESCRIPTION OF EMBODIMENTS

Hereinafter, an embodiment of the present disclosure will be described with reference to the drawings. Note that hereinafter, a visually impaired person may be simply referred to as a user. Furthermore, users in the present disclosure are not limited to visually impaired people.

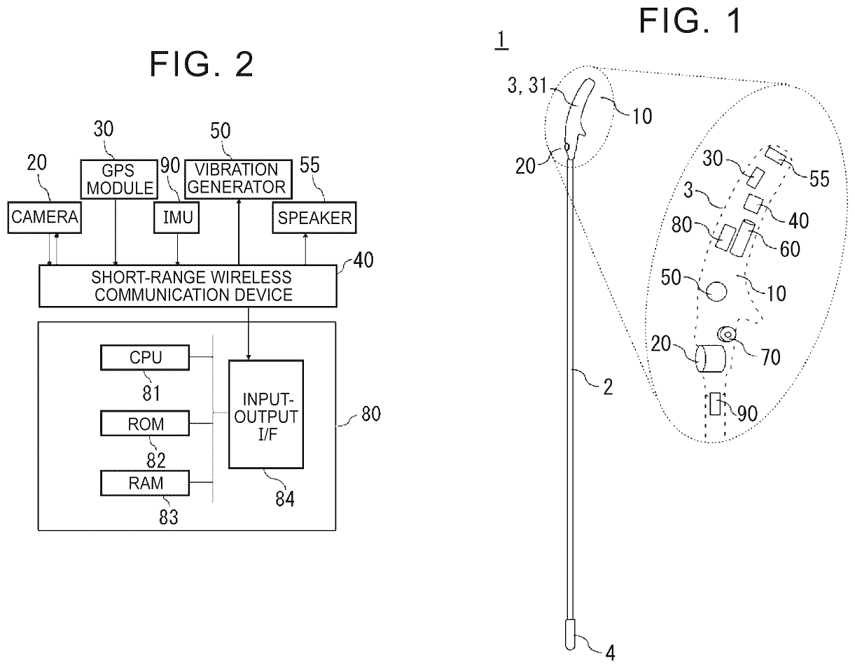

FIG. 1 is a diagram showing the system configuration of a mobility support system 10 and the appearance of a built-in white cane 1 according to the present embodiment. The mobility support system 10 supports the walking of a user who uses a white cane 1 by notifying the user of information. Each component of the mobility support system 10 is built into the grip portion 3 of the white cane 1.

The white cane 1 includes a shaft portion 2, a grip portion 3, and a tip portion (stone tip) 4. The shaft portion 2 is rod-shaped with a hollow substantially circular section, and is made of aluminum alloy, glass-fiber reinforced resin, carbon fiber reinforced resin, or the like.

The grip portion 3 is provided on a base end portion (upper end portion) of the shaft portion 2 and is configured by mounting a cover 31 made of an elastic body such as rubber. Moreover, the grip portion 3 has a shape in which the tip side (the upper side in FIG. 1) is slightly curved in consideration of the ease of holding and the difficulty of slipping when the user holds it. The configuration of the grip portion 3 is not limited to this.

The tip portion 4 is a substantially bottomed cylindrical member made of hard synthetic resin or the like, and is fitted onto the tip end portion of the shaft portion 2 and fixed to the shaft portion 2 by means such as adhesion or screwing. An end surface of the tip portion 4 on the tip end side has a hemispherical shape.

The white cane 1 according to the present embodiment is a straight cane that cannot be folded. However, the white cane 1 may be a cane that is foldable or expandable/contractable at an intermediate location or at a plurality of locations of the shaft portion 2.

FIG. 2 is a block diagram showing a schematic configuration of a control system of the mobility support system 10. As shown in FIGS. 1 and 2, the mobility support system 10 includes a camera (imaging device) 20, a GPS module 30, a short-range wireless communication device 40, a vibration generator 50, a speaker 55, a battery 60, a charging socket 70, an inertia It includes a measurement device (hereinafter referred to as an Inertial Measurement Unit (IMU)) 90, a control device 80, and the like.

The camera 20 is embedded in the front surface of the grip portion 3 at the base of the grip portion 3 (the surface facing the direction of movement of the user), and photographs the front side in the direction of movement of the user (front side in the direction of walking).

As is well known, the GPS module 30 receives signals transmitted from a plurality of artificial satellites and position-fixed fixed stations, and measures the position of the white cane 1 (approximately the user's position) with high accuracy.

The short-range wireless communication device 40 is a wireless communication device for performing short-range wireless communication between the camera 20, the GPS module 30, the IMU 90, and the control device 80. For example, short-range wireless communication is performed between the camera 20, the GPS module 30, the IMU 90, and the control device 80 using a well-known communication means such as Bluetooth (registered trademark), and information of an image (camera image) taken by the camera 20, user position information, and information measured by the IMU 90 (triaxial acceleration and triaxial angular velocity information) are wirelessly transmitted to the control device 80.

The vibration generator 50 is disposed, for example, at the base of the grip portion 3. The vibration generator 50 vibrates with the operation of the built-in motor, and by transmitting the vibration to the grip portion 3, various notifications (instructions) are sent to the user who is gripping the grip portion 3. It is now possible to do so.

The speaker 55 is disposed, for example, at the upper end of the grip portion 3. The speaker 55 is used to give various notifications (instructions and alerts) to the user by emitting audio to the user.

The battery 60 is composed of a secondary battery, and stores power for the GPS module 30, the short-range wireless communication device 40, the vibration generator 50, the speaker 55, the control device 80, and the IMU 90.

The charging socket 70 is a part where a charging cable is connected when storing electric power in the battery 60. For example, the charging cable is connected when the user charges the battery 60 from a household power source while at home.

The IMU 90 is equipped with a triaxial gyro and a 3-direction accelerometer, and these measure the 3-dimensional acceleration (triaxial acceleration) and angular velocity (triaxial angular velocity) at the location of the IMU 90 on the white cane 1. Note that the IMU 90 may include a built-in sensor such as a pressure gauge or GPS in order to improve reliability.

The control device 80 includes, for example, a processor such as a Central Processing Unit (CPU) 81, a Read-Only Memory (ROM) 82 that stores a control program, a Random-Access Memory (RAM) 83 that temporarily stores data, and It is equipped with 84 input/output I/Fs.

The input/output I/F 84 is capable of receiving information on a camera image taken by the camera 20 and information on the user's position from the GPS module 30 via the short-range wireless communication device 40. Further, the information receiving unit 81 can also receive information on the triaxial acceleration and triaxial angular velocity measured by the IMU 90 via the short-range wireless communication device 40. Furthermore, at least one of the camera image information, the user's position information, and the triaxial acceleration and triaxial angular velocity information includes time zone information such as time. Thereby, the input/output I/F 84 receives the current time zone information (information such as month and day, day of the week, time, etc.) while the user is moving. Note that the control device 80 may have a built-in clock, and the input/output I/F 84 may receive the current time zone information from the clock.

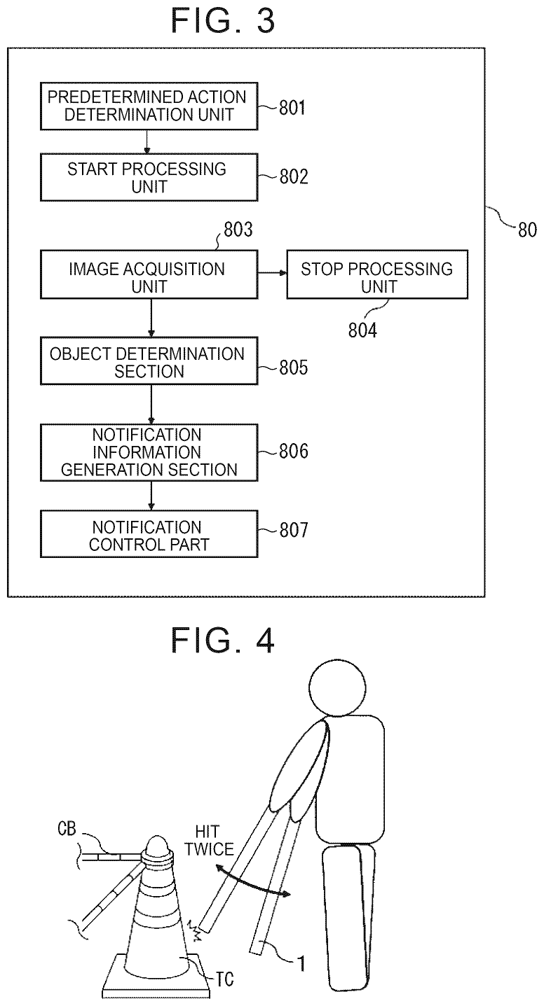

FIG. 3 is a block diagram showing the functional configuration of the control device 80. As shown in FIG. 3, the control device 80 includes, as the functional configuration, a predetermined action determination unit 801, a start processing unit 802, an image acquisition unit 803, a stop processing unit 804, an object determination unit 805, a notification information generation unit 806, and a notification control unit 807. Note that each functional configuration is realized by the CPU 81 reading out and executing a control program stored in the ROM 82.

The predetermined action determination unit 801 determines whether or not the user has performed a predetermined action using the white cane 1. Here, the predetermined action may be stored in advance in the control device 80 or in a server (not shown) (a server that can communicate with the mobility support system 10).

The predetermined action will be described below with reference to FIG. 4. FIG. 4 is a diagram for explaining a predetermined action in this embodiment. FIG. 4 shows a situation where, while the user is walking using the white cane 1, the user encounters a triangular cone TC and a cone bar CB, which are not included in the map data, on the user's path. In this embodiment, from the viewpoint of power consumption of the battery 60, the camera 20 is normally stopped, and the camera 20 is activated according to the user's intention to check an object. In the above scene, when the white cane 1 touches the triangular cone TC on its path, the user stops and tries to use the white cane 1 to check what it is that he touched, as shown in FIG. 4. Further, some users may stop and use the white cane 1 to check whether there is a triangular cone TC in the vicinity. Specifically, the predetermined action is a predetermined action when the user is standing still, and the predetermined action is an action of the user using the white cane 1 to confirm what is the object touched by the white cane 1, or a user's action of using the white cane 1 to check whether there is an object in the vicinity is determined.

For example, when the predetermined action determination unit 801 determines that (1) the user is standing still, the predetermined action determination unit 801 determines that (2) there was an action of the user hitting the same object (the triangular cone TC in the scene shown in FIG. 4) multiple times using the white cane 1 as the predetermined action. Regarding (1), for example, if there is no change in the user's position information for a certain period of time, it may be determined that the user is standing still. Regarding (2), it can be determined based on the movement of the white cane 1, that is, based on the information on the triaxial acceleration and triaxial angular velocity measured by the IMU 90, whether or not the above-mentioned predetermined action has occurred. For example, the correlation between triaxial acceleration and triaxial angular velocity measured when hitting the same object with white cane 1 is stored, and the measured triaxial acceleration and triaxial angular velocity are memorized. If the correlation is true, it may be determined that the predetermined action has occurred. Note that the number of times the user hits the same object multiple times may include hitting twice as a more natural action of the user, but the number of times is not limited.

The start processing unit 802 executes a start process of the camera 20 when the predetermined action determination unit 801 determines that a predetermined action has occurred. The start processing unit 802 outputs a camera activation signal to the camera 20 via the short-range wireless communication device 40, for example.

The image acquisition unit 803 acquires a camera image captured by the camera 20 after the camera 20 is activated by the start processing unit 802.

The stop processing unit 804 executes a process to stop the camera 20 when the camera image is acquired by the image acquisition unit 803. The stop processing unit 804 outputs a camera stop signal to the camera 20 via the short-range wireless communication device 40, for example.

The object determination unit 805 determines the imaged object from the information of the camera image acquired by the image acquisition unit 803. A method for determining an object captured in a camera image includes, for example, R-CNN using deep learning, but various known methods can be applied.

The notification information generation unit 806 generates notification information to notify the user from the user's position information, camera image information, triaxial acceleration and triaxial angular velocity information, and the object information determined by the object determination unit 805. Examples of the notification information include object information captured in a camera image, guidance information for avoiding the object, and the like.

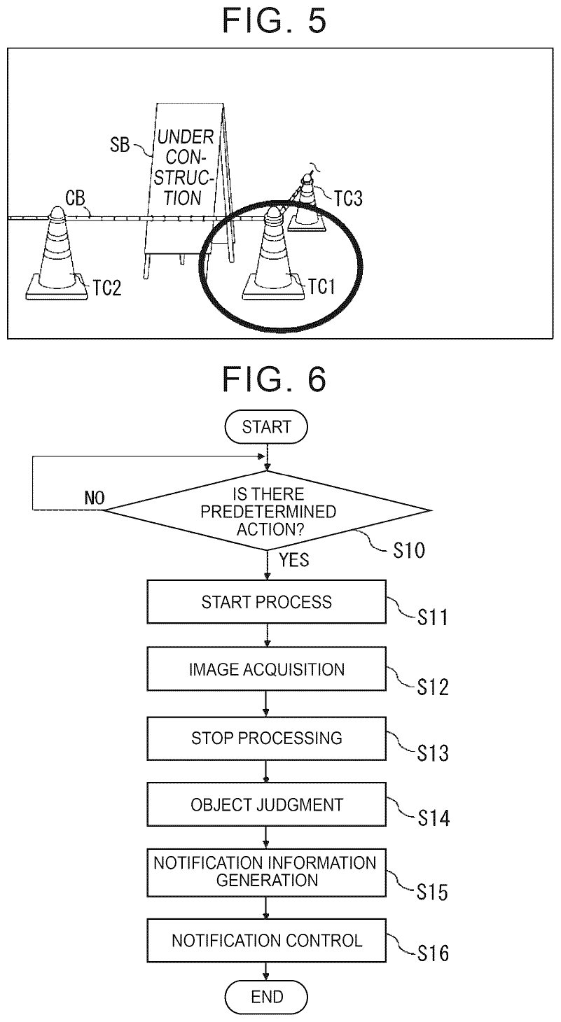

The notification information will be explained below with reference to FIG. 5. FIG. 5 shows an image captured by the camera 20 in the scene shown in FIG. 4.

When the camera image shown in FIG. 5 is acquired by the image acquisition unit 803, the object determination unit 805 determines that the object hit by the user is the triangular cone TC1. In addition to the triangular cone TC1, the camera image in FIG. 5 also includes the cone bar CB and the signboard SB. It is estimated that the object hit by the user is the triangular cone TC1 from the information of the triaxial acceleration and triaxial angular velocity measured by the IMU 90 and the information of the camera image.

When the notification information generation unit 806 receives object information indicating that the object hit by the user is the triangular cone TC1 from the object determination unit 805, the notification information generation unit 806 generates notification information notifying the user that the object hit is the triangular cone TC1. For example, audio notification information such as “What you just hit is a triangular cone” is generated.

The notification control unit 807 outputs the notification information generated by the notification information generation unit 806 to the vibration generator 50 or the speaker 55. At this time, guidance information for avoiding the object may be notified to the user at the same time. For example, when the camera image shown in FIG. 5 is acquired, it may be determined that it is impossible to proceed to the far left of the camera image, and a notification may be made to guide the user to the right. Obstacle avoidance guidance using image recognition in this case is performed using various known methods.

Next, the flow of processing executed by the control device 80 will be described with reference to the flowchart of FIG. 6.

First, in S10 (hereinafter, the word “step” is omitted) corresponding to the function of the predetermined action determination unit 801, when it is determined that the user is standing still based on the information on the user's position, it is determined whether the user has performed a predetermined action using the white cane 1 (an action in which the user uses the white cane 1 to hit the same object multiple times) from the information of the triaxial acceleration and triaxial angular velocity. Note that when a negative determination is made in S10, the processing in S10 is repeatedly executed until an affirmative determination is made in S10. Further, if an affirmative determination is made in S10, the process proceeds to S11.

Next, in S11 corresponding to the function of the start processing unit 802, a start process is executed to output a camera activation signal to the camera 20 via the short-range wireless communication device 40.

Next, in S12 corresponding to the function of the image acquisition unit 803, an image captured by the camera 20 after the camera 20 has been activated by executing the start process in S11 is acquired.

Next, in S13 corresponding to the function of the stop processing unit 804, when the camera image is acquired in S12, a stop process of outputting a camera stop signal to the camera 20 via the short-range wireless communication device 40 is executed.

Next, in S14 corresponding to the function of the object determination unit 805, the imaged object is determined from the information of the camera image acquired in S12.

Next, in S15, which corresponds to the function of the notification information generation unit 806, the notification information to be notified to the user is generated from the information of the position of the user, the information of the camera image, the information of the triaxial acceleration and triaxial angular velocity, and the object information determined in S12. As described above, the notification information includes object information captured in a camera image, guidance information for avoiding the object, and the like.

Next, in S16 corresponding to the function of the notification control unit 807, the notification information generated in S15 is output to the vibration generator 50 or the speaker 55 and notified to the user. Note that the sound provided to the user is not limited to the above-mentioned sounds, and may be other sounds such as a beep sound. Further, the notification information may be notified to the user by the vibration generator 50 vibrating in a pattern according to the notification information. When the notification information is notified by vibration of the vibration generator 50, the user can appropriately obtain the notification information even if the user is visually and hearing impaired.

After completing the process of S16, the control device 80 ends the series of processes in the flowchart of FIG. 6.

Next, the effects of this embodiment will be explained.

As described above, the control device 80 of the present embodiment can activate the camera (imaging device) 20 used when supporting the user's movement according to the user's intention to check an object, that is, according to the user's needs. Thus, there is no need to keep the camera 20 activated all the time. Therefore, the power required for the mobility support system 10 can be reduced.

It is also possible to start the camera 20 using a switch, but if the number of switches mounted on the white cane 1 increases, it may cause erroneous operation. By activating the camera 20 based on the movement of the white cane 1, the number of switches mounted on the white cane 1 can be reduced.

Note that in the above embodiment, the predetermined action is an action in which the user uses the white cane 1 to hit the same object multiple times, but the predetermined action is not limited to the above embodiment, and may be any action that indicates the user's intention to check the object. Any motion that can be detected may be used, and an unusual motion of the user using the white cane 1 may be regarded as the predetermined motion. Moreover, the predetermined action is not limited to the predetermined action when the user is standing still.

Further, in the embodiment described above, when it is determined that a predetermined action has occurred, a camera activation signal is output to the camera 20 via the short-range wireless communication device 40. However, if it is determined that a predetermined action has taken place, the user may be asked whether to start the camera. That is, in order to suppress erroneous determination of the intention to check an object, confirmation regarding activation of the imaging device may be performed in advance by voice guidance such as “Do you want to activate the camera?” or by vibration. In this case, the process of asking the user whether to start the camera corresponds to the start process. Note that the method of responding to the inquiry is not limited, and the user can respond by voice or by a gesture of hitting an object with a white cane.

Further, the configuration and arrangement position of the camera 20 are not limited to those described above. The camera 20 is configured as a relatively wide-angle camera, and has a built-in mechanism for rotating the camera 20 around a vertical axis, and is configured to be able to acquire images of the user's surroundings by rotating the camera 20 using this mechanism. Good too. Further, in addition to the front surface of the grip portion 3, a camera similar to the camera 20 may be embedded in the back surface of the grip portion 3. According to this, it is possible to obtain images not only of the front side of the user but also of the rear side. For example, if a bicycle approaches from behind the user, it may be possible to recognize the bicycle's approach from the camera image.

What is claimed is:

1. A control device used in a mobility support system that supports walking of a user using a white cane by notifying the user of information, wherein:
the white cane includes an imaging device;
the information is generated based on an image captured by the imaging device; and
the control device includes
a predetermined action determination unit that determines whether the user has performed a predetermined action using the white cane based on a movement of the white cane, and
a start processing unit that executes a start process of the imaging device when the predetermined action determination unit determines that the predetermined action has been performed.

2. The control device according to claim 1, wherein the movement of the white cane is a movement of the white cane when the user is standing still, and the predetermined action is a predetermined action when the user is standing still.

3. The control device according to claim 1, wherein the predetermined action is an action in which the user hits the same object multiple times using the white cane.

4. The control device according to claim 1, further comprising:
an image acquisition unit that acquires an image captured by the imaging device after the imaging device is started by the start processing unit; and
a stop processing unit that executes a stop process of the imaging device when the image is acquired by the image acquisition unit.
